(19) United States
(12) Patent Application Publication
(10) Pub. No.: US 2017/0226914 A1
(43) Pub. Date: Aug. 10, 2017

(54) FAN FOLD BONDED METAL CATALYST SUBSTRATE AND METHOD FOR CONSTRUCTING THE SAME

(71) Applicant: ACAT Global, Charlevoix, MI (US)

(72) Inventor: Jonathan R. Shawl, Central Lake, MI (US)

(73) Assignee: ACAT Global, Charlevoix, MI (US)

(21) Appl. No.: 15/519,042

(22) PCT Filed: Oct. 14, 2015
(86) PCT No.: PCT/US2015/055440

§ 371 Date: Apr. 13, 2017

Related U.S. Application Data
(60) Provisional application No. 62/064,144, filed on Oct. 15, 2014.

(51) Int. Cl. F01N 3/28; B01J 35/04; B01J 37/02

(52) U.S. Cl. CPC F01N 3/2814; B01J 37/0225; B01J 35/04

(57) ABSTRACT

A fan fold resistance bonded metal catalyst substrate is disclosed as well as a method for forming the same. In one method, a length of a continuous sheet of foil is moved bidirectionally through a corrugators. The corrugator engages with the foil sheet to form a corrugated shape in the foil; each of the corrugated shapes have a profile to form substantially “V” shaped corrugations along the length of said foil. The continuous sheel of corrugated foil is fan folded at predetermined places along the length of the corrugagted foil into a fan folded corrugated continous foil shape. The shape has at least two layers of opposed corrugated foil in facing relation to each other. The V shaped corrugations in each layer are positioned relative to each other to form a substantially consistent diamond pattern between opposed separate layers in a substrate face of the fan folded corrugated continuous foil sheet shape.

### CROSS-REFERENCE TO RELATED APPLICATION

This application claims the benefit of and priority to PCT Application No. PCT/US2015/055440, filed Oct. 14, 2015 and U.S. Provisional Patent Application No. 62/064,144 filed on Oct. 15, 2014, which are hereby incorporated by reference in their entireties.

### TECHNICAL FIELD

Previous metal catalyst substrates have been made of individual metal foil segments and stacked to form a “herringbone” configuration, and bonded at the joints of the layers to form the stacked foil layers. One problem with this type of construction is that the bonded joints between the stacked herringbone foil layers are subject to failure when subjected to Noise, Vibration and Harshness (NVH), especially during operation or during Hot Shake conditions.

The method of manufacturing fan folded metal catalyst substrates as described in the preceding section generally requires a manual alignment and placement of the cut and stacked foil layers into the bonding fixture, which is both time consuming and difficult. In addition the foil layers can become disoriented by flipping over during the cut operation causing nesting of the corrugated layers. Layers can be missed from the stack, or layers may be out of sequential order. In addition, current cut and stack methods require a corrugated foil to be special spooled onto two spools and then one spool is required to be rewound in the reverse direction for the herringbone configuration pattern to stack up. The pieces of fan folded metal catalyst subtrates are cut and manually stacked to form the desired pattern, and the entire assembly is then placed in a weld fixture to join the layers together into an integral structure. It is understood that the current cut and stack/fold method as is difficult to fully automate, especially with regard to the alignment of the folded metal catalyst substrate layers into the desired pattern and placement of the folded metal catalyst substrate layers into a weld fixture.

It has been found that a continuous sheet of metal catalyst foil arranged in a fan fold configuration according to at least one embodiment of the present disclosure, can provide for as many various geometries as the stack layer methods set forth above for forming a fan folded metal catalyst substrate. In addition, it has been found that such an arrangement eliminates the problem of positioning the cut foil during stacking, keeping the proper alignment of the foil layers during bonding, minimizes irregular patterns seen in the cut and stack method due to foil layer position shifts that may occur during processing and improved exhaust gas flow through. The disclosed methods also lend themselves to full automation of the manufacturing process, thereby reducing costs and improving consistency as between each fan folded methal catalyst substrate made using the method of the instant application.

Certain technical and manufacturing advantages may be realized by implementing the embodiment(s) as described. For example, a continuous sheet of foil that is fan folded into a corrugated shape offers a one piece construction with no sharp edges. The elimination of sharp endeges is an advance in the art as it facilitates better handling of the fan folded substrate during manuifacturing. In addition, the fan fold method forms a consistent diamond pattern on a the completed fan fold metal catalyst substrate face. The consistent diamond pattern possible in the embodiments of the present disclosure permit unrestricted exhaust gas flow through, and more surface area of the metal catalyst fan fold substrate is exposed to the exhaust gas stream to facilitate improved emission control. Moreover, the fan fold metal catalyst substrate of the present disclosure offers presents less potential for slippage relative to stacked and folded metal catalyst layers if the bonds used in the fan fold metal catalyst made according to the present disclosure are compromised due to its one piece construction, than if the bonds are compromised in fan fold metal catalyst substrate made using a prior stack and fold method.

A one piece construction also has manufacturing advantages. Among these is that the flow path of the foil can go directly from the spool to the corrugator to a fan fold device. There is no need for a corrugated foil spool reversal. Folded foil layers will stay in the correct sequence and orientation, and the possibility of a lost layer is eliminated. The fan fold method as set forth in disclosed embodiments addresses weld failures by using one continuous strip of foil. The foil is folded back and forth to create any desired shape having any desired configuration between the folds such as a diamond shaped herringbone configuration. The use of the continuous foil also improves shear strength of the finished product over fan folded metal catalyst substrates made accordining to the cut and stack method.

### BRIEF DESCRIPTION OF THE DRAWINGS

FIG. 1 is a representation of an unbonded corrugated fan fold metal substrate foil;

FIG. 2 is a representation of a partial on end view of an exhaust gas aftertreatment component equipped with fan fold metal catalyst substrate face showing a substantially regular diamond pattern on a substrate face made according to one embodiment;

FIG. 3 is a representation of a partial on end view of an exhaust gas aftertreatment component equipped with a fan folded metal catalyst showing a substantially irregular diamond pattern on the substrate face made according to a cut and stack method;

FIG. 4 is a side view comparison of an exhaust component with folded metal catalyst substrate made according to one emboidument of the instant applcaition compared to an exhaust component with a folded metal catalyst substrate formed by the cut and stack method;

FIG. 5A is a schematic representation of a front view of a folding tool for making the fan fold metal substrate;

FIG. 5B is a scamatic representation of a side view of one method to make the fan fold using a bi-directional folding tool;

FIG. 6 is a perspective view of several different shapes of a fan fold corrugated structure according to one embodiment of the disclosure.

### DETAILED DESCRIPTION

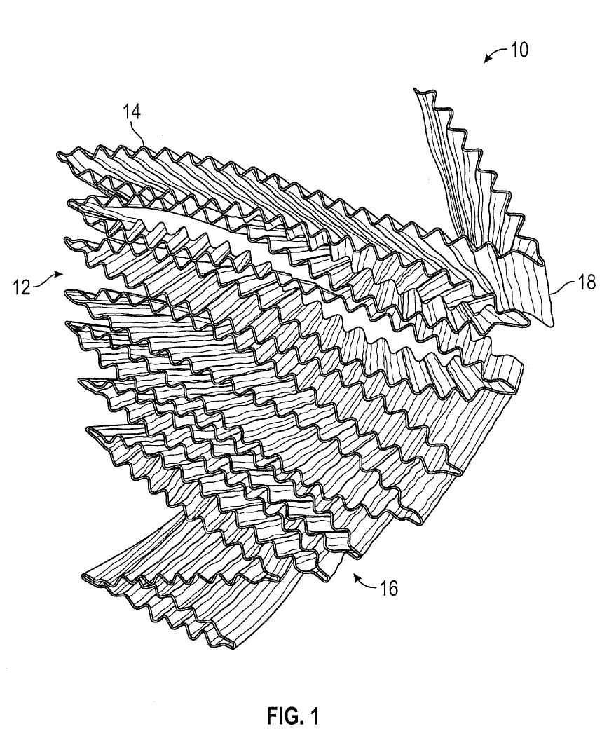

Turning now to the drawings wherein like numbers refer to like structures, and particualry to FIG. 1, there is depicted therein an unbounded, corrugated fanfold metal catalyst substrate 10. The substrate has a one continuous sheet construction 12, with a multiplicity of corrugations 14 along substantially its length 16. At each fold 18 along the length of the metal catalyst substrate, the metal foil is folded rather than joint bonded, as might be the case if individual foil layers were used to create a substrate. As will be discussed, the substrate may folded at any point(s) along the length of the substrate to form any shape or geometry as desired. The substrate may be a metal foil, or any other material that is suitable for use as a catalyst substrate. While the metal catalyst substrate will be discussed as used for an exhaust gas aftertreatment component, it is to be understood that the embodiments of this application may be used to create any catalyst substrate structure.

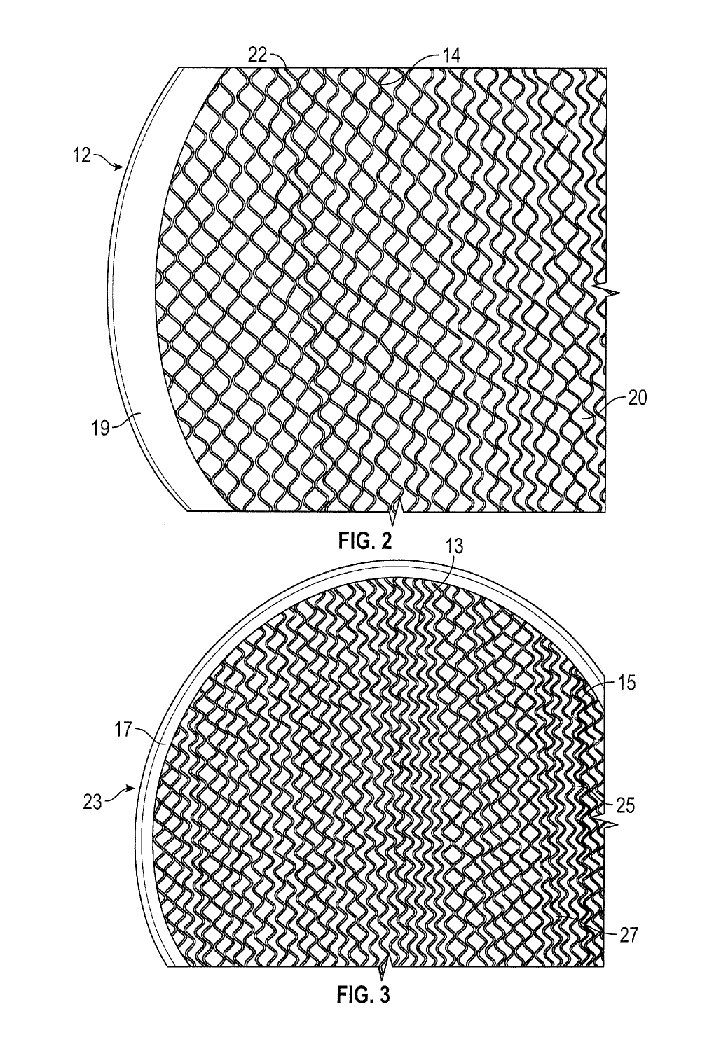

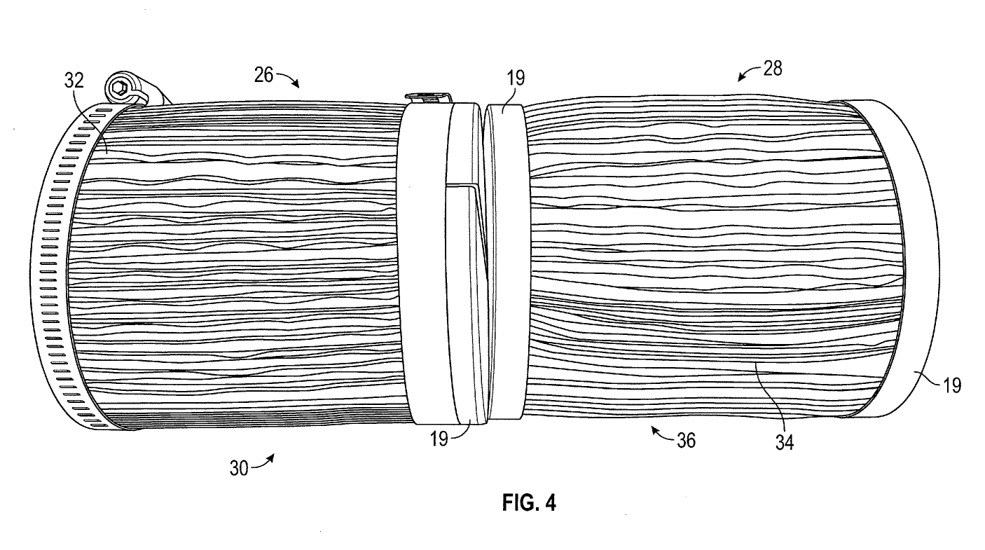

FIG. 2 shows a partial on end view of exhaust gas aftertreament component 21 equipped with a fan folded metal catalyst substate 22 made according to one embodiment of the present disclosure. The exhaust gas aftertreatement component has an outer periphery ring 19 surrounding the substrate at least at its end peripheries (as seen in FIG. 4) and the substrate presents fan fold face 20 with a substantially uniform diamond pattern 24 formed when the metal foil is folded in such a way that corrugations 14 are arranged to intersect each other and form the diamond pattern.

FIG. 3 is a partial on end view of an exhaust gas aftertreatment component 23 equipped with a fan folded metal catalyst 25 made according to a cut and stack method. The exhaust gas aftertreatment has an outer periphery ring 17 surrounding the substrate at least at its end peripheries (as seen in FIG. 4) and the substate presents a fan fold face 27 with substantially irregular diamond pattern 29 on the substrate face. Individual stacks 24 of the folded metal catalyst substrate are cut to shape and manually stacked to form a substrate and joint bonded at their ends to form a metal catalyst face. The cut and stack method of manufacture results in an irregular diamond shaped pattern, and has significant areas where the stacked substrates assume a nest 15 configuration along substantial portions 13 of substrate face. The nesting of the corrugations in the individual stacked layers results in constriction of exhaust gas flowthorugh, with resulting backpressure to the engine. It has been a long standing problem in the art that unless the operator is extremely careful it is difficult to consistently arrange individual stacks 24 of corrugated foil in such a way as to form the neat diamond pattern as seen in FIG. 2.

The improved regularity of the diamond pattern is apparent when comparing the pattern formed in FIG. 2 to the diamond patterns formed in the substrate according to FIG. 3. FIG. 3 is a cut and stack face as is known in the art wherein the stack is made of individual foil layers that are stacked into position and joint bonded at the joints to form a metal catalyst face. It is apparent that the foil layers corrugations 14 do not neatly stack up relative to each other to form a substantially regular diamond pattern in the face of the substrate.

FIG. 4 is a side by side comparison of the fan fold catalyst substrate 26 of one embodiment of the present disclosure against the cut and stack catalyst substrate 28. Specifically, exhaust gas aftertreatement component 30 is made accorindg to the fan fold method of one embodiment of the present disclosure. The configuration of the folds 32 in the substrate present a fairly regular order and spacing. The aftertreatemetn component 36 is made according tot eh cut and stack method and presents bonded joints 34 where the cut stacks are bonded together , as by welding. The configuration of the bonded joints in component 36 is less well ordered when comnpared to the configuration of the fan folds in component 30. It is clear that the fanfold substrate has a more ordered structure than the cut and stack catalyst substrate.

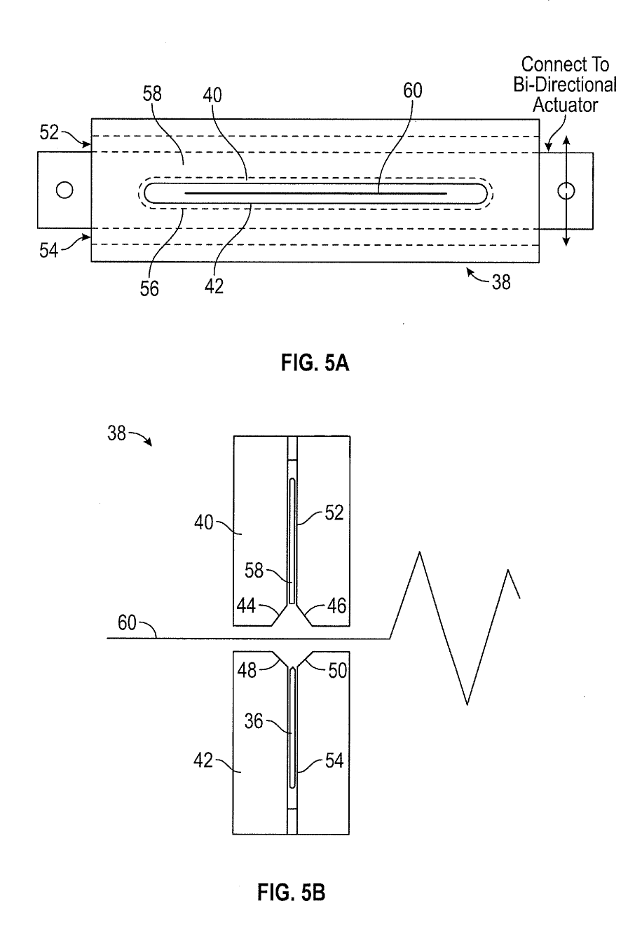

Turning now to FIGS. 5A and 5B, there is depicted therein a representation of a bi directional folding tool 38 showing opposed dies 40 and 42, respectively. The tool is connected to a bi directional actuator to force the dies together on the moving foil to create the folds in the foil. The folds may be concave or convex or may be concave on one side of the foil and convex on the side or surface of the foil. For purposes of explanation, a V shape will be disussed.

The dies have angled die surfaces 44, 46, 48 and 50, respectively, to form the fan folds when the tool is operated. Each opposed die has a recess 52, 54, repectively within which is disposed fan fold tool inserts 56 and 58 respectively, reciprocally moveable within said recesses. The fan folding tool dies are made of a hard material such steel, and tool inserts may be made of composite hardened powdered metals such a tungsten carbide or other hardened metal inserts so that the inserts have long lofe and are harder than the material that they will encounter when making the as is well known in the art. In operation, a sheet of metal foil 60 is moved bi directionally between the opposed dies. The tools 40 and 42 are positioned relative to each other so that when the dies are moved into engagement with the metal foil, the inserts are sequentially moved into engagement with the foil and force the foil to bend, thereby creating the fan folds in the metal foil. In one example, the fan fold substrate can be made by moving a sheet of metal foil substrate bi-directionally in a folding tool having dies that when moved together impart an angled fold into the substrate at a predetermined place on the substrate.

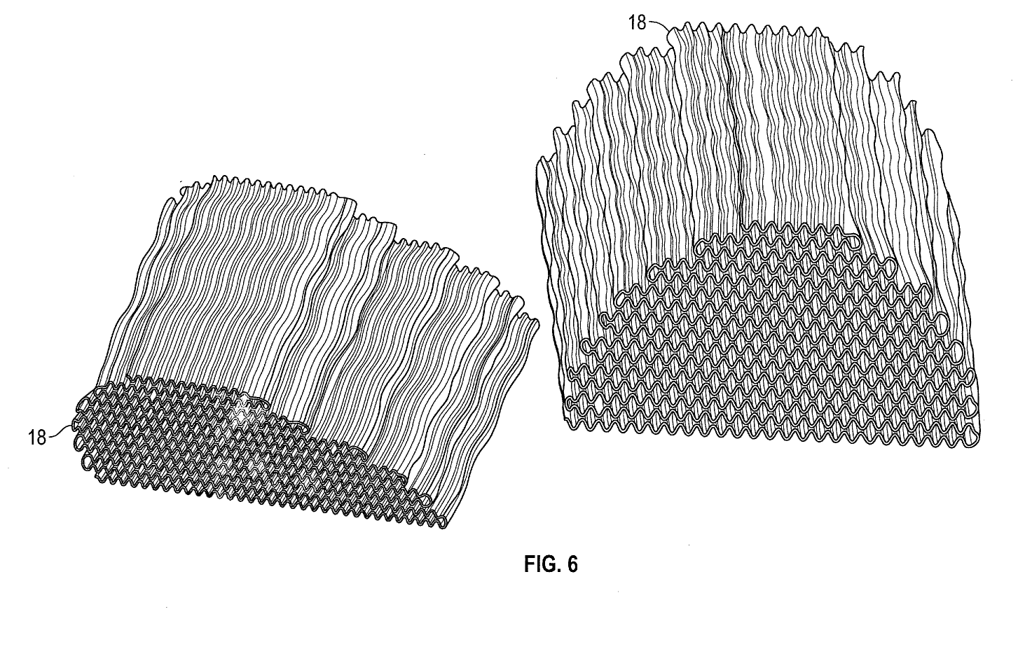

FIG. 6 shows some different shapes that could be made according to the method of the instant disclosure. In one method, the one piece corrugated foil is folded into many fan folds to create a corrugated metal substrate of the desired semi circular geometric configuration 62 that is not joint bonded at the edges, but rather is folded to conform to the geometric shape as desired and then an outer periphery is applied to the folded substrate to keep the folded substrate in place. The folds in the substrate stack relatively uniformly to present a face having a substantially uniform diamond shaped configuration betweenthe folds. In another emblodient, substrate 64 presents an irregular figure having a rounded side 66 and a stepped side 68. Note again that the folds in the substrate stack relatively uniformly to present a face having a substantially uniform diamond shaped configuration betweenthe folds

While one embodiment has been described, it is apparent to those skilled in the art that many variations and modifications are possible without departing from the scope and spirit of the concept as described. Moreover, it is understood that the terminology used in this application are words of description and not words of limitation.

1. A method to make a one piece fan folded, corrugated continuous foil sheet shape, comprising:
bidirectionally moving a length of a continuous sheet of foil through a corrugator;
engaging said corrugator with the foil sheet to form a corrugated shape in the foil; each of said corrugated shapes having a profile to form substantially “V” shaped corrugations along said length of said foil; fan folding the continous sheet of corrugated foil at predetermined places along the length of the corrugagted foil into a fan folded corrugated continous foil shape, said shape having at least two layers of opposed corrugated foil in facing relation to each other; positioning said V shaped corrugations in each said layer relative to each other to form a substantially consistent diamond pattern between opposed separate layers in a substrate face of said fan folded corrugated continuous foil sheet shape.

2. The method of claim 1, further including moving said foil directly from a spool through said corrugator.

3. The method of claim 1, wherein said corrugator is a pair of opposed dies; said dies equipped with tools reciprocally carried in recesses within said dies, said tools operational bidirectionally to impart corrugations in said continuous sheet of foil.

4. The method of claim 1, wherein said folded foil elilminates sharp edges between said layers.

5. The method of claim 1 wherein slippage between the layers is reduced, thereby contributing to more consistent diamond shaped corrugations beween the layers.

6. The method of claim 1, wherein the continuous foil layer is foled back and forth to form a substrate.

7. The method of claim 1, wherein said method imparts improved shear strength to a shape substrate over fan folded metal substrate made according to a cut and stack method.

8. The method of claim 1, wherein said contrnuous foil sheet is a metal catalyst sheet.

9. A one piece fan folded metal catalyst substrate, comprising a length of a continuous sheet of corrugated metal foil; said corrugations in said foil occurring along said length of said foil, said corrugations substantially concave along one side of said length and convex along an opposite of side of said foil; said foil bendable at predetermined places along its length to form layers of a substrate, said layers arranged such that said corrugations are in opposed relationship to each other to form a substantially consistent pattern in said substrate.

10. The one piece fan folded metal catalyst substrate of claim 9, wherein said corrugations are V shaped.

11. The one piece fan folded metal catalyst substrate of claim 9, wherein said corrugations are in a substantially uniform opposed relation to each other between layers in said substrate.

12. The one piece fan folded metal catalyst substrate of claim 9, wherein shear strength of the substrate is improved over fan folded metal catalyst substrates made accordining to a cut and stack method.
